(19) United States
(12) Patent Application Publication
(10) Pub. No.: US 2009/0116538 A1
(43) Pub. Date: May 7, 2009

(54) PERFORMANCE TESTING APPARATUS FOR HEAT PIPES

(75) Inventor: TAY-JIAN LIU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: FOXCONN TECHNOLOGY CO., LTD., Tu-Cheng (TW)

(21) Appl. No.: 12/171,249

(22) Filed: Jul. 10, 2008

(30) Foreign Application Priority Data
Nov. 2, 2007 (TW) 96141369

(51) Int. Cl. G01K 13/00

(52) U.S. Cl. 374/147

(57) ABSTRACT

A heat pipe performance testing apparatus includes a heating set, a cooling set, and a supporting set adjustably supporting the heating and cooling sets thereon. The heating set includes a first immovable portion, and a first movable portion vertically movable to the first immovable portion. A first channel is defined between the first immovable and movable portions. Temperature sensors are attached to the first immovable and movable portions. Heating members are attached to the first movable and immovable portions. The heating members are parallel to the temperature sensors. The cooling set includes a second immovable portion and a second movable portion vertically movable to the second immovable portion. A second channel is defined between the second immovable portion and the second movable portion. Temperature sensors are attached to the second immovable and movable portions. A cooling passageway is formed in the second immovable portion.

### BACKGROUND OF THE INVENTION

1. Field of the Invention

The present invention relates generally to testing apparatuses, and more particularly to a performance testing apparatus for heat pipes.

2. Description of Related Art

It is well known that a heat pipe is generally a vacuum-sealed pipe. A porous wick structure is provided on an inner face of the pipe, and phase changeable working media employed to carry heat is included in the pipe. Generally, according to where the heat is input or output, a heat pipe has three sections, an evaporating section, a condensing section and an adiabatic section between the evaporating section and the condensing section.

In use, the heat pipe transfers heat from one place to another place mainly by exchanging heat through phase change of the working media. Generally, the working media is a liquid such as alcohol or water and so on. When the working media in the evaporating section of the heat pipe is heated up, it evaporates, and a pressure difference is thus produced between the evaporating section and the condensing section in the heat pipe. The resultant vapor with high enthalpy rushes to the condensing section and condenses there. Then the condensed liquid reflows to the evaporating section along the wick structure. This evaporating/condensing cycle continually transfers heat from the evaporating section to the condensing section. Due to the continual phase change of the working media, the evaporating section is kept at or near the same temperature as the condensing section of the heat pipe. Heat pipes are used widely owing to their great heat-transfer capability.

In order to ensure the effective working of the heat pipe, the heat pipe generally requires testing before being used. The maximum heat transfer capacity (Qmax) and the temperature difference (ΔT) between the evaporating section and the condensing section are two important parameters in evaluating performance of the heat pipe. When a predetermined quantity of heat is input into the heat pipe through the evaporating section thereof, thermal resistance (Rth) of the heat pipe can be obtained from ΔT, and the performance of the heat pipe can be evaluated. The relationship between these parameters Qmax, Rth and ΔT is Rth=ΔT/Qmax. When the input quantity of heat exceeds the maximum heat transfer capacity (Qmax), the heat cannot be timely transferred from the evaporating section to the condensing section, and the temperature of the evaporating section increases rapidly.

A typical method for testing the performance of a heat pipe is to first insert the evaporating section of the heat pipe into a liquid at constant temperature; after a period of time the temperature of the heat pipe will become stable; then, a temperature sensor such as a thermocouple, a resistance thermometer detector (RTD) or the like can be used to measure ΔT between the liquid and the condensing section of the heat pipe to evaluate the performance of the heat pipe. However, Rth and Qmax can not be obtained by this test, and the performance of the heat pipe can not be reflected exactly by this test.

Referring to FIG. 8, a related performance testing apparatus for heat pipes is shown. The apparatus has a resistance wire 1 coiling round an evaporating section 2a of a heat pipe 2, and a water cooling sleeve 3 functioning as a heat sink and enclosing a condensing section 2b of the heat pipe 2. In use, electrical power controlled by a voltmeter and an ammeter flows through the resistance wire 1, whereby the resistance wire 1 heats the evaporating section 2a of the heat pipe 2. At the same time, by controlling flow rate and temperature of cooling liquid entering the cooling sleeve 3, the heat input at the evaporating section 2a can be removed from the heat pipe 2 by the cooling liquid at the condensing section 2b, whereby a stable operating temperature of adiabatic section 2c of the heat pipe 2 is obtained. Therefore, Qmax of the heat pipe 2 and ΔT between the evaporating section 2a and the condensing section 2b can be obtained by temperature sensors 4 at different positions on the heat pipe 2.

However, in the test, the related testing apparatus has the following drawbacks: a) it is difficult to accurately determine lengths of the evaporating section 2a and the condensing section 2b which are important factors in determining the performance of the heat pipe 2; b) heat transference and temperature measurement may easily be affected by environmental conditions; and, c) it is difficult to achieve sufficiently intimate contact between the heat pipe and the heat source and between the heat pipe and the heat sink, which results in uneven performance test results of the heat pipe. Furthermore, due to awkward and laborious assembly and disassembly in the test, the testing apparatus can be only used in the laboratory, and can not be used in the mass production of heat pipes.

In mass production of heat pipes, a large number of performance tests are needed, and the apparatus is used frequently over a long period of time; therefore, the apparatus not only requires good testing accuracy, but also requires easy and accurate assembly to the heat pipes to be tested. The testing apparatus affects the yield and cost of the heat pipes directly; therefore, testing accuracy, facility, speed, consistency, reproducibility and reliability need to be considered when choosing the testing apparatus. Therefore, the testing apparatus needs to be improved in order to meet the demand for mass production of heat pipes.

What is needed, therefore, is a high performance testing apparatus for heat pipes suitable for use in mass production of heat pipes.

### SUMMARY OF THE INVENTION

A performance testing apparatus for heat pipes in accordance with a first embodiment of the present invention comprises a heating set for heating an evaporating section of the heat pipe, a cooling set for cooling a condensing section of the heat pipe, and a supporting set adjustably supporting the heating set and the cooling set thereon. The heating set comprises a first immovable portion and a first movable portion being vertically movable relative to the first immovable portion. A first channel is defined between the first immovable portion and the first movable portion for receiving the evaporating section of the heat pipe. A temperature sensor is attached to at least one of the first immovable portion and the first movable portion for detecting temperature of the evaporating section of the heat pipe. A heating member is attached to at least one of the first movable portion and the immovable portion. The temperature sensor and the heating member are parallel to each other. The cooling set comprises a second immovable portion and a second movable portion being vertically movable relative to the second immovable portion. A second channel is defined between the second immovable portion and the second movable portion for receiving the condensing section of the heat pipe. A temperature sensor is attached to at least one of the second immovable portion and the second movable portion. A cooling passageway is formed in one of the second immovable portion and the movable portion. Orientations of the heat set and cooling set are adjustable so that the performance testing apparatus can test heat pipes having different configurations, for example, straight shape, L shape and U shape.

### BRIEF DESCRIPTION OF THE DRAWINGS

Many aspects of the present performance testing apparatus for heat pipes can be better understood with reference to the following drawings. The components in the drawings are not necessarily drawn to scale, the emphasis instead being placed upon clearly illustrating the principles of the present performance testing apparatus for heat pipes. Moreover, in the drawings, like reference numerals designate corresponding parts throughout the several views.

FIG. 1 is an assembled view of a performance testing apparatus for heat pipes in accordance with a first embodiment of the present invention.

FIG. 2 is an exploded, isometric view of the performance testing apparatus for heat pipes of FIG. 1.

FIG. 3 shows a first immovable portion and an insulating member of a heating set of the performance testing apparatus for heat pipes of FIG. 2.

FIG. 4 is an assembled view of FIG. 3.

FIG. 5 is an assembled view of a performance testing apparatus for heat pipes in accordance with a second embodiment of the present invention.

FIG. 6 shows the performance testing apparatus for heat pipes of FIG. 5 in a different state.

FIG. 7 is an assembled view of a performance testing apparatus for heat pipes in accordance with a third embodiment of the present invention.

FIG. 8 is a performance testing apparatus for heat pipes in accordance with related art.

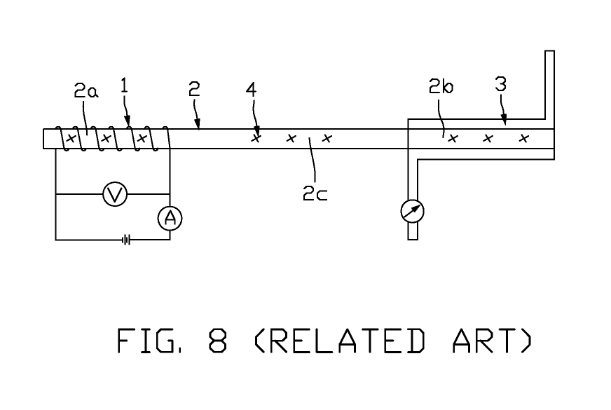

### DETAILED DESCRIPTION OF THE INVENTION

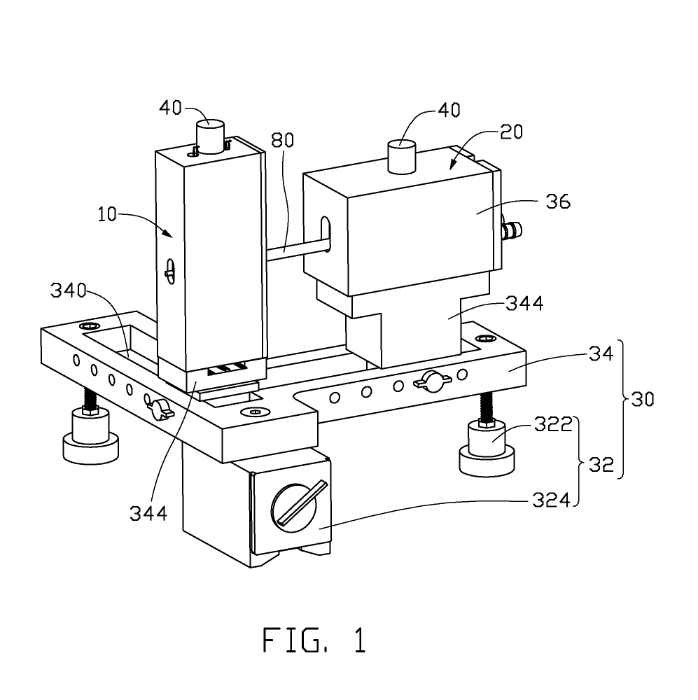

Referring to FIG. 1, a performance testing apparatus for heat pipes of the first embodiment of the present invention is shown. The testing apparatus comprises a heating set 10 for heating an evaporating section of a heat pipe 80, a cooling set 20 for cooling a condensing section of the heat pipe 80, and a supporting set 30 supporting the heating set 10 and the cooling set 20 thereon.

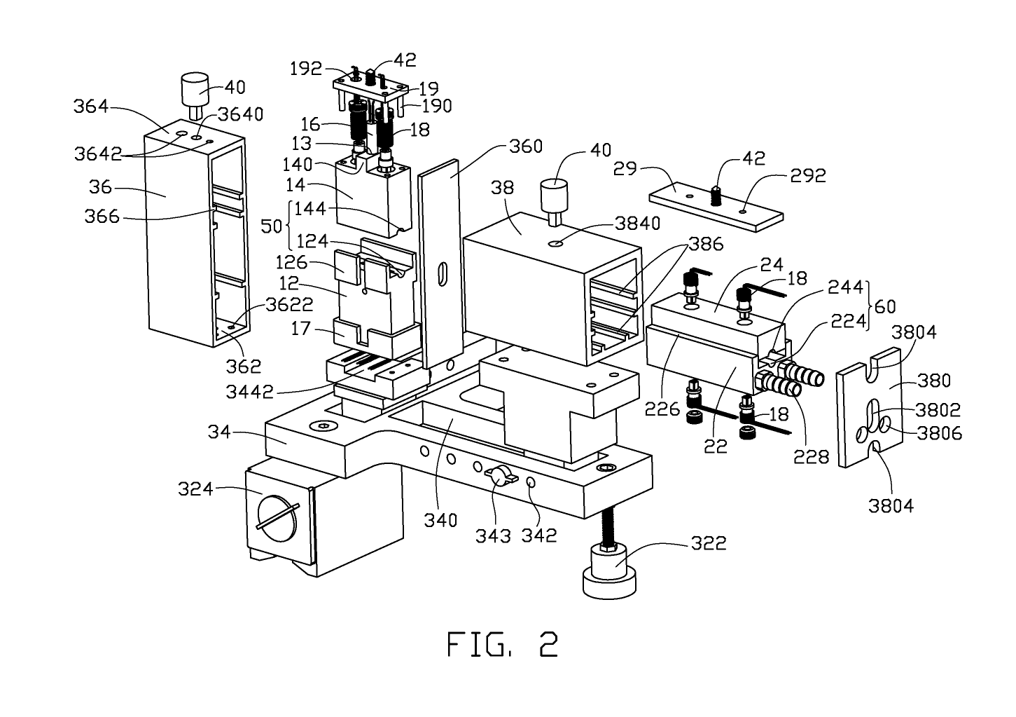

Referring also to FIG. 2, the heating set 10 comprises a first immovable portion 12 and a first movable portion 14 positioned on the first immovable portion 12. The first movable portion 14 is vertically movable relative to the first immovable portion 12.

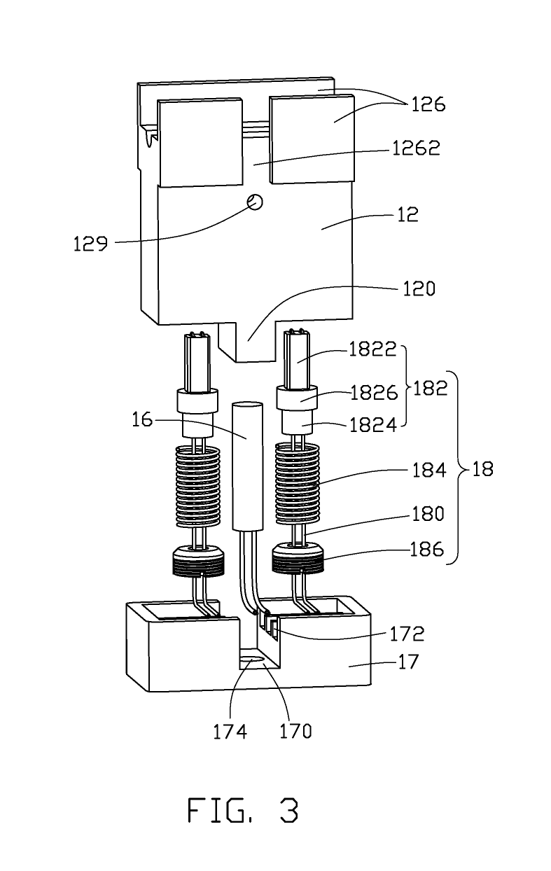

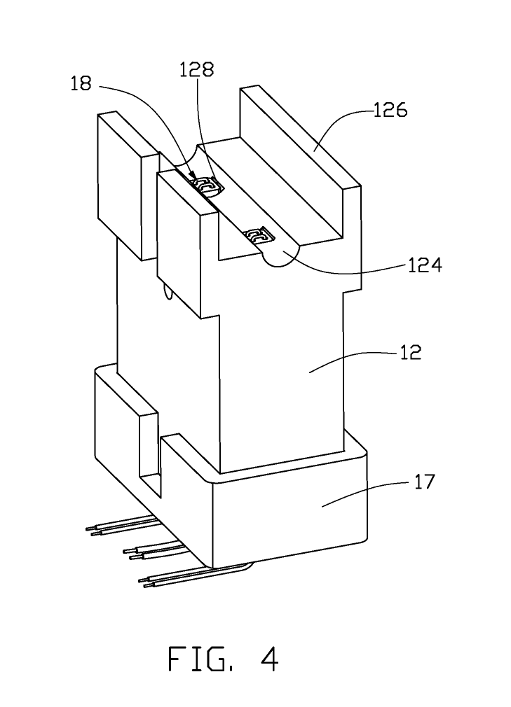

Referring also to FIGS. 3 and 4, the first immovable portion 12 is made of material having good heat conductivity. A first heating member 16 such as an immersion heater, resistance coil, quartz tube and Positive temperature coefficient (PTC) material or the like is embedded in the first immovable portion 12. The first immovable portion 12 has a central portion thereof extending a first extension 120 downwardly. The first immovable portion 12 defines a hole (not shown) in the first extension 120. In this case, the first heating member 16 is an elongated cylinder. The first heating member 16 is accommodated in the hole and thermally contacts an inner face of the first immovable portion 12 defining the hole. Two spaced wires (not shown) extend beyond the first extension 120 from a bottom end of the first heating member 16 for connecting with a power supply (not shown). The first immovable portion 12 has a first heating groove 124 defined in a top face thereof, for receiving an evaporating section of the heat pipe 80 to be tested therein. Two first temperature sensors 18 are accommodated in two through holes 128 defined in the first immovable portion 12 at two sides of the extension 120. The through holes 128 extend through the first immovable portion 12 from a top face to a bottom face thereof. The through holes 128 are in communication with the first heating groove 124. The two first temperature sensors 18 are accommodated in corresponding through holes 128 and have detecting sections thereof exposed to the first heating groove 124. In this embodiment, the first heating member 16 is perpendicular to the first heating groove 124. Furthermore, the first heating member 16 is parallel to the first temperature sensors 18.

Each of the two first temperature sensors 18 comprises a positioning socket 182 fitted in the hole 128 and a pair of thermocouple wires 180 fitted in the socket 182. The socket 182 comprises a square column 1822, a circular column 1824 below the square column 1822, and a circular collar 1826 between the square column 1822 and the circular column 1824. The socket 182 has two pairs of through apertures (not shown) extending through the socket 182 from the square column 1822 to the circular column 1824. Each wire 180 has two positioning sections (not labeled) extending into the apertures of the socket 182. The detecting section (not labeled) is located between the two positioning sections at an end of the socket 182. Each wire 180 has a connecting section extending from one of the two positioning sections and through an orifice (not labeled) of a screw 186 to connect with a monitoring computer (not shown). The hole 128 has a configuration similar to the socket 182, whereby the socket 182 can be fitted in the hole 128. A spring coil 184 is located between the screw 186 and the circular collar 1826 and surrounds the circular column 1824 and the positioning sections of the wires 180. The spring coil 184 is compressed between the screw 186 threadedly engaging in a bottom of the hole 128 of the first immovable portion 12 and the circular collar 1826 of the socket 182. The detecting sections are exposed in the first heating groove 124 and capable of automatically contacting the evaporating section of the heat pipe 80 to detect the temperature of the evaporating section.

The first movable portion 14 is also made of material having good heat conductivity. The first movable portion 14 has an extension 140 extending upwardly from a middle of a top surface thereof. The first movable portion 14 defines a hole 13 in the extension 140. A second heating member 16 is accommodated in the hole 13 of the first movable portion 14. Two spaced wires (not labeled) extend from a top end of the second heating member 16 beyond the extension 140 for connecting with the power supply. The first movable portion 14, corresponding to the first heating groove 124 of the first immovable portion 12, has a second heating groove 144 defined in a bottom face thereof, whereby a testing channel 50 is cooperatively defined by the first, second heating grooves 124, 144 when the first movable portion 14 moves to reach the first immovable portion 12. When the first movable portion 14 moves to the first immovable portion 12, an intimate contact between the evaporating section of the heat pipe 80 and the first movable, immovable portions 14, 12 can be realized, thereby reducing heat resistance between the evaporating section of the heat pipe 80 and the first movable, immovable portions 14, 12. The first movable portion 14 has two through holes (not labeled) defined at two opposite sides of the second heating member 16 to accommodate two first temperature sensors 18 therein. The through holes each are in communication with the second heating groove 144. Each of the two temperature sensors 18 has the detecting section (not labeled) thereof located in the second heating groove 144. The detecting sections are capable of automatically contacting the evaporating section of the heat pipe 80 to detect the temperature of the evaporating section. In this embodiment, the second heating member 16 is perpendicular to the second heating groove 144.

In this embodiment, the first immovable portion 12 has two flanges 126 integrally extending upwardly and toward the first movable portion 14 from two opposite outer sides of an upper portion thereof. An outer face of each flange 126 extends outwardly beyond a corresponding outer face of a main body (not labeled) of the first immovable portion 12. The two flanges 126 function as a positioning structure to position the first movable portion 14 therebetween, thereby preventing the first movable portion 14 from deviating from the first immovable portion 12 during test of the heat pipe 80 and other heat pipes in mass production. The two flanges 126 ensure the grooves 124, 144 of the first immovable, movable portions 12, 14 to always be aligned with each other. Thus, the channel 50 can be always precisely and easily formed for receiving the evaporating section of the heat pipe 80 for test. The first movable portion 14 slidably contacts the two flanges 126 of the first immovable portion 12 when it moves relative to the first immovable portion 12. Alternatively, the first movable portion 14 can have two flanges slidably engaging two opposite sides of the first immovable portion 12 to keep the first immovable portion 12 aligned with the first movable portion 14. In this embodiment, the first immovable portion 12 defines a bore 129 in a side face thereof and below one of the flanges 126 for receiving a second temperature sensor therein to detect a temperature of the first heating member 16 and the first immovable portion 12, when the first movable portion 14 moves away the first immovable portion 12. The flange 126 corresponding to the bore 129 defines a through slot 1262 for allowing wires of the second temperature sensor to extend upwardly therethrough.

In order to construct a thermally steady environment for testing the heat pipes 80, the heating set 10 is enclosed in a cuboidal first enclosure 36. The first enclosure 36 has a bottom 362 positioned on the supporting set 30 and three interconnecting sidewalls (not labeled) extending upwardly from the bottom 362. An entrance (not labeled) is defined in an opened side of the first enclosure 36 for disposing, assembling or dismantling the first movable portion 14 and the first immovable portion 12 in the first enclosure 36. A door board 360 is removably attached to the entrance for facilitating the first immovable portion 12 and the first movable portion 14 entering into/exiting out of the first enclosure 36. Two opposite ones of the sidewalls form a plurality of ribs 366 on inner faces thereof, for reducing contacting area between the heating set 10 and the first enclosure 36. Corresponding to the first channel 50 between the first immovable portion 12 and the first movable portion 14, openings (not labeled) are defined in the door board 360 and the sidewall of the first enclosure 36 facing to the door board 360. A ceiling 364 of the first enclosure 36 defines two spaced through bores 3642 to allow wires of the second heating member 16, the first temperature sensors 18 in the first movable portion 14 extending therethrough to connect with the power supply (not shown) and a monitoring computer (not shown).

In order to prevent heat in the first immovable portion 12 from spreading to the first enclosure 36, a thermally insulating member 17 is located in the first enclosure 36 and at the bottom of the first immovable portion 12 to separate the bottom of the first immovable portion 12 from the bottom 362 of the first enclosure 36. The insulating member 17 receives a bottom portion of the first immovable portion 12 therein. The insulating member 17, corresponding to the extension 120 of the first immovable portion 12, defines a concave 170 receiving the extension 120 therein. At two sides of the concave 170, a plurality of ribs 172 extends from a bottom of the insulating member 17 to support the bottom of the first immovable portion 12 thereon. The bottom 362 of the first enclosure 36 defines a hole 3622 corresponding to the insulating member 17 for the wires of the first heating member 16 and the wires of the first temperature sensors 18 of the first immovable portion 12 to extend therethrough to connect with the power supply and the monitoring computer.

A board 19 is positioned over the first movable portion 14. Four columns 190 are secured at corresponding four corners of the first movable portion 14 and extend upwardly to engage in corresponding four through holes (not labeled) defined in four corners of the board 19. The board 19 defines two spaced orifices 192 corresponding to the through bores 3642 of the ceiling 364 of the first enclosure 36 for allowing extension of the wires of the second heating member 16 and the first temperature sensors 18 therethrough.

A driving device 40 is fixed on the ceiling 364 of the first enclosure 36. A shaft of the driving device 40 threadedly engages with a bolt 42 which is secured to the board 19 and extends through a hole 3640 defined in the ceiling 364. A space (not labeled) is defined between the board 19 and the ceiling 364 of the first enclosure 36 for movement of the first movable portion 14 in the first enclosure 36. When the driving device 40 operates, the shaft rotates and the bolt 42 with the board 19 and the first movable portion 14 moves vertically upwardly or downwardly relative to the first immovable portion 12 in the first enclosure 36. The driving device 40 in this embodiment is a step motor, although it can be easily apprehended by those skilled in the art that the driving device 40 can also be a pneumatic cylinder or a hydraulic cylinder. In use, the driving device 40 accurately drives the first movable portion 14 to move linearly relative to the first immovable portion 12. For example, the first movable portion 14 can be driven to depart a certain distance such as 5 millimeters from the first immovable portion 12 to facilitate the insertion of the evaporating section of the heat pipe 80 being tested into the channel 50 or withdrawn from the channel 50 after the heat pipe has been tested. On the other hand, the first movable portion 14 can be driven to move toward the first immovable portion 12 to thereby realize an intimate contact between the evaporating section of the heat pipe 80 and the first immovable and movable portions 12, 14 during the test. Accordingly, the requirements for testing, i.e. accuracy, ease of use and speed, can be realized by the testing apparatus in accordance with the present invention.

The cooling set 20 comprises a second immovable portion 22 and a second movable portion 24 vertically movably located on the second immovable portion 22.

The second immovable portion 22 is made of metal having good heat conductivity. Cooling passageways (not shown) are defined in an inner portion of the second immovable portion 22, to allow coolant to flow in the second immovable portion 22. An inlet 228 and an outlet 228 extend from a lateral side of the second immovable portion 22 to communicate the passageways with a constant temperature coolant circulating device (not shown); therefore, the passageways, inlet 228, outlet 228 and the coolant circulating device cooperatively define a cooling system for the coolant circulating through the second immovable portion 22 to remove heat from the condensing section of the heat pipe 80 in test. The second immovable portion 22 has a cooling groove 224 defined in a top face thereof, for receiving the condensing section of the heat pipe 80. Two first temperature sensors 18 are inserted into through holes (not shown) defined in the second immovable portion 22 from a bottom of the second immovable portion 22 so as to position detecting portions (not labeled) of the first temperature sensors 18 in the cooling groove 224. The detecting portions of the first temperature sensors 18 are capable of automatically contacting the condensing section of the heat pipe 80 in order to detect a temperature of the condensing section.

The second movable portion 24 is also made of metal having good heat conductivity. The second movable portion 24, corresponding to the cooling groove 224 of the second immovable portion 22, has a cooling groove 244 defined therein, whereby a second channel 60 is cooperatively defined by the cooling grooves 224, 244 when the second movable portion 24 moves to reach the second immovable portion 22. Thus, an intimate contact between the condensing section of the heat pipe 80 and the second movable and immovable portions 24, 22 defining the second channel 60 can be realized, thereby reducing heat resistance between the heat pipe 80 and the second movable and immovable portions 24, 22. Two first temperature sensors 18 are inserted into through holes (not labeled) defined in the second movable portion 24 from a top thereof to reach a position wherein detecting portions (not labeled) of the second temperature sensors 18 are located in the cooling groove 244 and capable of automatically contacting the condensing section of the heat pipe 80 to detect the temperature of the condensing section.

In this embodiment, in order to precisely position the second movable portion 24 relative to the immovable portion 22, the immovable portion 22 has two flanges 226 integrally extending upwardly from two opposite top edges thereof and toward the second movable portion 24. The outer face of each flange 226 is coplanar with the outer face of a main body (not labeled) of the second immovable portion 22. The two flanges 226 function as a positioning structure to position the second movable portion 24 therebetween, which prevents the second movable portion 24 from deviating from the second immovable portion 22 during test of the heat pipes 80 in mass production, thereby ensuring the cooling grooves 224, 244 of the second immovable and movable portions 22, 24 to always be aligned with each other. When the second movable portion 24 moves to the second immovable portion 22, the second channel 60 can be always precisely and easily formed for receiving the condensing section of the heat pipe 80 for test. Outer faces of the second movable portion 24 slideably contact the two flanges 226 of the second immovable portion 22 when the second movable portion 24 moves relative to the second immovable portion 22. Alternatively, the second movable portion 24 can have two flanges slideably engaging with two opposite sides of the second immovable portion 22 to keep the second immovable portion 22 aligned with the second movable portion 24.

The cooling set 20 is accommodated in a cuboidal second enclosure 38. The second enclosure 38 has a bottom (not labeled) positioned on the supporting set 30 and three interconnecting sidewalls (not labeled) extending upwardly from the bottom. An entrance (not labeled) is defined in an opened side of the second enclosure 38 for disposing, assembling or dismantling the second movable portion 24 and the second movable portion 22 in the second enclosure 38. A door board 380 is removably attached to the entrance for facilitating the second immovable portion 22 and the second movable portion 24 entering into/exiting out of the second enclosure 38. The bottom and two opposite ones of the sidewalls form a plurality of ribs 386 on inner faces thereof, for reducing contacting area between the cooling set 20 and the second enclosure 38. A slot (not labeled) is defined between two ribs 386 of the bottom for extension of wires of the first temperature sensor 18 of the second immovable portion 22 to connect with the monitoring computer. Corresponding to the second channel 60 between the second immovable portion 22 and the second movable portion 24, two lengthwise openings 3802 are defined in the door board 380 and one of sidewalls of the second enclosure 38 which faces to the door board 380, respectively, for extension of the condensing section of heat pipe 80 into the second channel 60 via the opening 3802, wherein the opening in the sidewall of the second enclosure 38 is not shown. Corresponding to the inlets 228, outlets 228 of the second immovable portion 22, the second enclosure 38 defines two through bores 3806 in the door board 380, for allowing the inlets, outlets, 228, 228 to extend out of the second enclosure 38. The door board 380 defines two cutouts 3804 in an upper portion and a lower portion thereof for allowing wires of the first temperature sensors 18 extending therethrough to connect with the monitoring computer. A board 29 is secured to a top of the second movable portion 24 in the second enclosure 38. The board 29 defines two spaced apertures 292 for allowing the wires of the first temperature sensors 18 of the second movable portion 24 to extend therethrough. A space (not labeled) is left between the board 29 and a ceiling of the second enclosure 38 for movement of the second movable portion 24. A bolt 42 is fixed to the board 29. The ceiling of the second enclosure 38 defines a through hole 3840 for extension of the bolt 42 to engage with a shaft of a driving device 40. When the driving device 40 operates, the shaft rotates and the board 29 and the second movable portion 24 move vertically upwardly or downwardly away from or toward the second immovable portion 22 in the second enclosure 38, thereby realizing intimate contact between the condensing section of the heat pipe 80 and the second movable and immovable portions 24, 22. In this manner, heat resistance between the condensing section of the heat pipe 80 and the second movable and immovable portions 24, 22 can be minimized.

The channel 50, 60 as shown in the first embodiment each have a circular cross section enabling it to receive the evaporating section, condensing section of the heat pipe 80 each having a correspondingly circular cross section. Alternatively, the channels 50, 60 each can have a rectangular cross section when the evaporating section and the condensing section of the heat pipe each also have a flat, rectangular configuration.

The supporting set 30 comprises a supporting leg 32, a supporting platform 34 on the supporting leg 32 and two supporting seats 344 positioned on the supporting platform 34 and respectively supporting the heating set 10 and the cooling set 20 thereon.

The supporting platform 34 is a rigid member and has a substantially T-shaped figure. The supporting platform 34 defines two guiding slots 340 corresponding to the two supporting seats 344. The two guiding slots 340 receive lower portions of the two supporting seat 344 therein, respectively. The two guiding slots 340 cooperatively define a T-shaped configuration. The two supporting seats 344 can make linear movement along the guiding slots 340. In addition, orientations of the supporting seats 344 relative to the guiding slots 340 can be altered by first lifting the supporting seats 344 to leave from the guiding slots 340 of the supporting platform 34, then rotating the supporting seats 344 to different orientations and finally remounting the supporting seats 344 back to the guiding slots 340, respectively. The supporting platform 34 defines a plurality of holes 342 in two lateral sides thereof, wherein the holes 342 communicate with the guiding slots 340. Corresponding to each supporting seat 344, a positioning bolt 343 is received in an appropriate one of the holes 342 and engages with the lower portion of the supporting seat 344, to thereby secure the supporting seat 344 at an appropriate position of the supporting platform 34 according to the figure and size of the heat pipe 80 to be tested. Corresponding to the heating set 10, the supporting seat 344 defines a trough 3442 in a top face thereof for extension of the wires of the first heating member 16 and the first temperature sensor 18 of the first immovable portion 12 from the first enclosure 36.

The supporting leg 32 comprises an electromagnetic holding chuck 324 supporting an end of the supporting platform 34, two adjustable feet 322 supporting other two ends of the supporting platform 34. The electromagnet holding chuck 324 is made from ferroalloy. The testing apparatus can be easily fixed at any desired position by controlling current through or out of the holding chuck 324 or adjusting the feet 322 according to tests of different heat pipes at different locations.

In use, an example according to the first embodiment of the present invention is shown to test performance of the linear heat pipe 80. The heat pipe 80 has an evaporation section at an end thereof and a condensing section at an opposite end thereof. The supporting set 30 is adjusted, wherein the two supporting seats 344 are adjusted to aligning the first channel 50 of the heating set 10 with the second channel 60 of the cooling set 20. The evaporating section of the heat pipe 80 extends through the opening of the sidewall of the first enclosure 36 and is received in the first channel 50 of the heating set 10. The condensing section of the heat pipe 80 extends through the opening 3802 of the door board 380 of the second enclosure 38 and is received in the second channel 60 of the cooling set 20. The driving devices 40 drive the first, second movable portions 14, 24 to move relative to the first, second immovable portion 12, 22 to allow the evaporating section and the condensing section in intimately contact with corresponding heating set 10 and cooling set 20. The power supply energizes the heating members 16 of the heating set 10; the evaporating section is thus heated. The coolant circulates in the cooling set 20; the condensing section is thus cooled. The first temperature sensors 18 and the second temperature sensors 18 work and detect temperature of the evaporating section and condensing section of the heat pipe 80. Therefore, performance of the heat pipe 80 can be obtained from the monitoring computer.

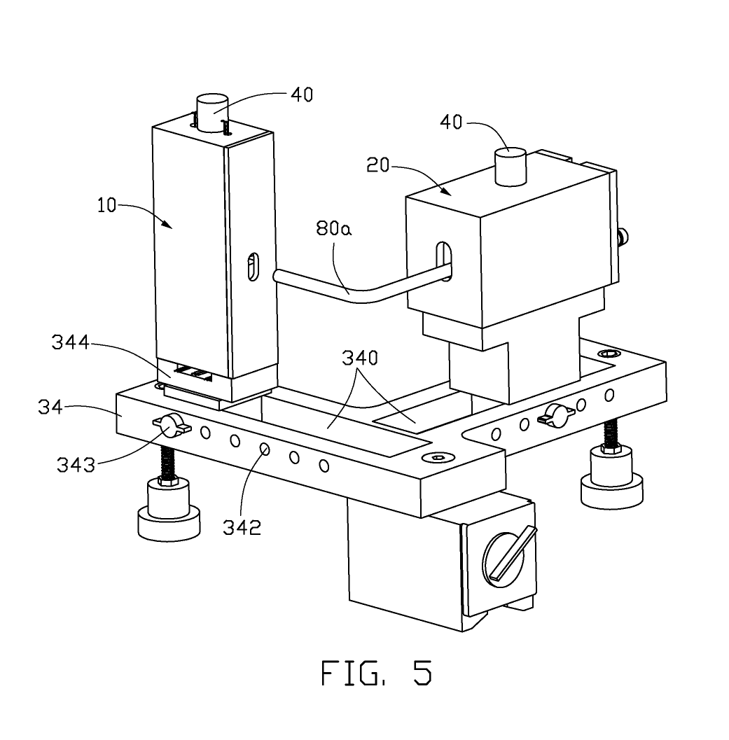

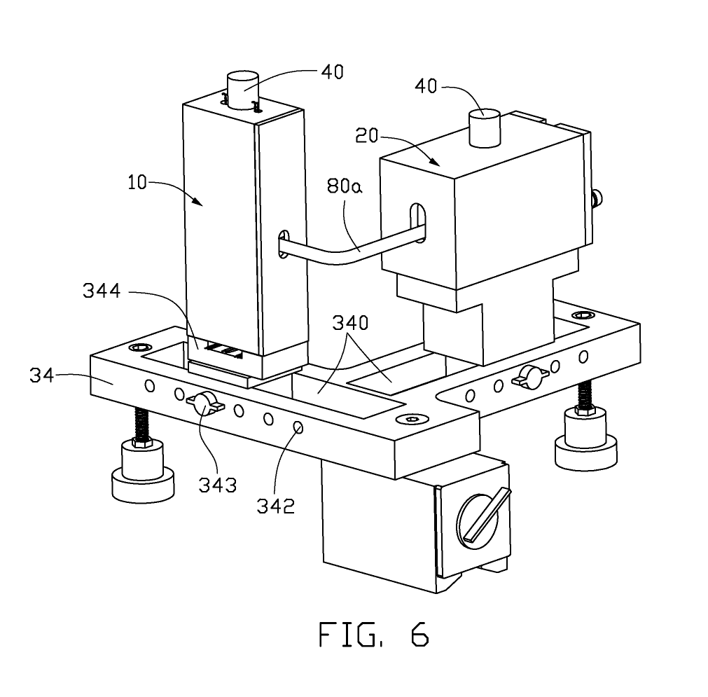

Referring to FIGS. 5 and 6, a performance testing apparatus for heat pipes in accordance with a second embodiment of the present invention is shown. The second embodiment is similar to the first embodiment; a difference therebetween is that the second embodiment is used to test performance of an L-shaped heat pipe 80a. The heat pipe 80a has an evaporating section and a condensing section substantially perpendicular to the evaporating section. When the heat pipe 80a is tested, the supporting set 30 is adjusted, wherein, in comparison with the first embodiment, the supporting seat 344 supporting the heating set 10 is rotated 90 degree to make the first channel 50 of the heating set 10 perpendicular to the second channel 60 of the cooling set 20. The two supporting seats 344 are secured with the supporting platform 34 via the bolts 343 engaging with the supporting seats 344 and the supporting platform 34. The evaporating section of the heat pipe 80a extends through the opening of the door board 360 of the first enclosure 36 to be received in the first channel 50 of the heating set 10. The condensing section of the heat pipe 80a extends through the opening of the sidewall of the second enclosure 38 to be received in the second channel 60 of the cooling set 20. The driving devices 40, the heating members 16, the cooling system and the temperature sensors 18 work, and performance of the heat pipe 80a is obtained from the monitoring computer.

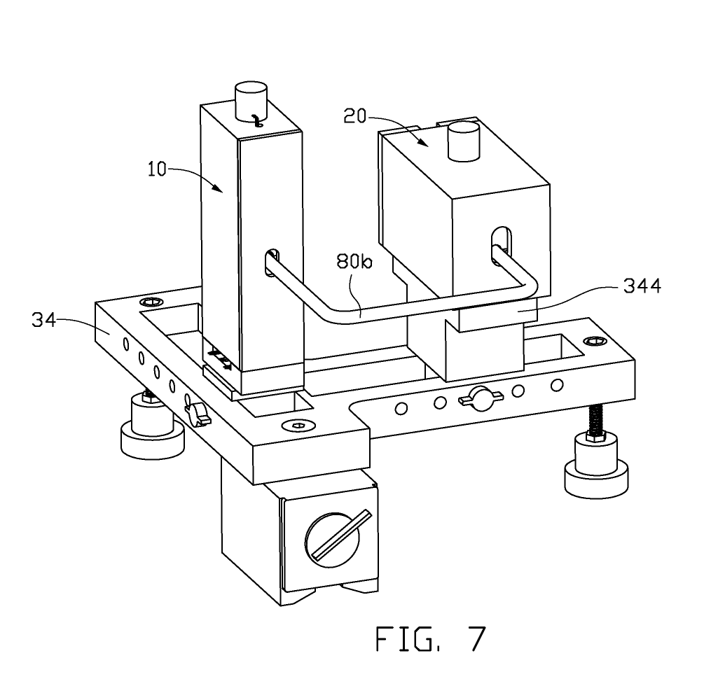

Referring to FIG. 7, a performance testing apparatus for heat pipes in accordance with a third embodiment of the present invention is shown. The third embodiment is similar to the first embodiment; a difference therebetween is that the third embodiment is used to test performance of a U-shaped heat pipe 80b. The heat pipe 80b has an evaporating section, a condensing section parallel to the evaporating section and a connecting section connecting the evaporating section and the condensing section. When the heat pipe 80b is tested, the supporting set 30 is adjusted, wherein, in comparison with the first embodiment, the supporting seats 344 are rotated 90 degree to make the first channel 50 of the heating set 10 parallel to the second channel 60 of the cooling set 20. The two supporting seats 344 are secured with the supporting platform 34 via the bolts 343 engaging with the supporting seats 344 and the supporting platform 34. The evaporating section of the heat pipe 80b extends through the opening of the door board 360 of the first enclosure 36 and is received in the first channel 50 of the heating set 10. The condensing section of the heat pipe 80b extends through the opening of the sidewall of the enclosure 38 and is received in the second channel 60 of the cooling set 20. The driving devices 40, the heating members 16, the cooling system and the temperature sensors 18 work, and performance of the heat pipe 80b is obtained from the monitoring computer.

Additionally, in the present invention, in order to lower cost of or simplify manufacture of the testing apparatus, the boards 19, 29, the socket 182, the supporting platform 34 and the first and second enclosures 36, 38 can be made from low-cost material such as PE (Polyethylene), ABS (Acrylonitrile Butadiene Styrene), PF (Phenol-Formaldehyde), PTFE (Polytetrafluoroethylene) and so on. The first, second immovable portions 12, 22, the first, second movable portions 14, 24 can be made from copper (Cu) or aluminum (Al). The first, second immovable portions 12, 22, the first, second movable portions 14, 24 can have silver (Ag) or nickel (Ni) plated on inner faces defining the channels 50, 60 to prevent the oxidization of the inner face.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A performance testing apparatus for a heat pipe comprising:
a heating set for heating an evaporating section of the heat pipe, the heating set comprising a first immovable portion, a first movable portion being vertically movable relative to the first immovable portion, a first channel being defined between the first immovable portion and the first movable portion for receiving the evaporating section of the heat pipe, a temperature sensor being attached to at least one of the first immovable portion and the first movable portion for detecting temperature of the evaporating section of the heat pipe, and a heating member being attached to at least one of the first movable portion and the immovable portion, the temperature sensor being parallel to the heating member;
a cooling set for cooling a condensing section of the heat pipe, the cooling set comprising a second immovable portion, a second movable portion being vertically movable relative to the second immovable portion, a second channel being defined between the second immovable portion and the second movable portion for receiving the condensing section of the heat pipe, a temperature sensor being attached to at least one of the second immovable portion and the second movable portion, and a cooling passageway is formed in one of the second immovable portion and the movable portion; and
a supporting set adjustably supporting the heating set and the cooling set thereon.

2. The testing apparatus of claim 1, wherein the supporting set comprises two supporting seats movable relative to each other, the heating set and the cooling set being seated on the two supporting seats, respectively.

3. The testing apparatus of claim 2, wherein the supporting set comprises a supporting platform, the two supporting seats being located on the supporting platform.

4. The testing apparatus of claim 3, wherein one of the supporting seats is capable of linearly moving on the platform.

5. The testing apparatus of claim 3, wherein an orientation of one of the supporting seats relative to the platform is adjustable.

6. The testing apparatus of claim 3, wherein the platform defines a guiding slot receiving a portion of one of the supporting seats therein.

7. The testing apparatus of claim 6, wherein the platform defines another guiding slot receiving a portion of another of the supporting seats therein.

8. The testing apparatus of claim 7, wherein the guiding slot is perpendicular to the another guiding slot.

9. The testing apparatus of claim 3, wherein supporting set comprises a supporting leg supporting the platform thereon.

10. The testing apparatus of claim 9, wherein the supporting leg comprises an electromagnetic holding chuck supporting an end of the platform, and two adjustable feet supporting other two ends of the platform.

11. The testing apparatus of claim 1, wherein the heating set is received in an enclosure located on one of the supporting sets.

12. The testing apparatus of claim 11, wherein the heating set and the enclosure have a thermally insulating member located therebetween.

13. The testing apparatus of claim 11, wherein the first movable portion of the heating set is driven by a driving device mounted outside the enclosure and engaging with the first movable portion.

14. The testing apparatus of claim 13, wherein the first movable portion of the heating set has a board located at a face thereof, the board engaging with the driving device.

15. The testing apparatus of claim 1, wherein at least one of the temperature sensors is pressed by a spring in one of the heating set and the cooling set.

16. The testing apparatus of claim 1, wherein the first immovable portion of the heating set extends two flanges toward the first movable portion for positioning the first movable portion therebetween.

17. The testing apparatus of claim 1, wherein second movable portion of the cooling set extends two flanges toward the second movable portion for positioning the second movable portion therebetween.

18. The testing apparatus of claim 1, wherein the first immovable portion has a temperature sensor therein to detect a temperature of the heating member.
